(19) United States
(12) Patent Application Publication
(10) Pub. No.: US 2014/0053094 A1
(43) Pub. Date: Feb. 20, 2014

(54) Electronic control and display unit

(71) Applicant: CLAAS SELBSTFAHRENDE ERNTEMASCHINEN GMBH, HARSEWINKEL (DE)

(72) Inventors: MARKUS GREVINGA, SAERBECK (DE); MICHAEL LOSCH, VERSMOLD (DE)

(73) Assignee: CLAAS SELBSTFAHRENDE ERNTEMASCHINEN GMBH, HARSEWINKEL (DE)

(21) Appl. No.: 13/962,308

(22) Filed: Aug. 8, 2013

(30) Foreign Application Priority Data
Aug. 17, 2012 (DE) 10 2012 107 551.4

(51) Int. Cl. G06F 3/0481

(52) U.S. Cl. CPC G06F 3/04817
USPC 715/771

(57) ABSTRACT

An electronic control and display unit comprises a display and at least one control unit. The display has a plurality of visualization regions and icons representing settings of parameters are assigned to the display in one or more visualization regions. A particular icon represents a parameter of a working machine. Activating the particular icon causes at least one virtual adjusting element to be shown on the display. The virtual adjusting element can be edited in order to change the parameter of the working machine.

### CROSS-REFERENCE TO A RELATED APPLICATION

The invention described and claimed hereinbelow is also described in German Patent Application DE 10 2012 107551.4, filed on Aug. 17, 2012. The German Patent Application, subject matter of which is incorporated herein by reference, provides the basis for a claim of priority of invention under 35 U.S.C. 119(a)-(d).

### BACKGROUND OF THE INVENTION

The invention relates to an electronic control and display unit including a display having a plurality of visualization regions, wherein icons representing the parameter settings are assigned to one or more of the visualization regions.

Various display devices are known that are used to visualize and edit processes, e.g., on mobile agricultural working machines. Document DE 102 03 370, for example, discloses a method for controlling a user interface, in which an interactive user interface permits the visualization of a plurality of control windows. In addition to the overlapping depiction of display windows, the aforementioned document proposes that when an additional display window is activated, the currently activated display window is reduced in size such that the content of all active display windows is visible.

Such known systems have the primary disadvantage, however, that a plurality of information is visualized directly on the screen even if the information does not need to be monitored or edited at the time. This large amount of information can result in the overstimulation of an operator of the machine since a considerable amount of information is always accessible and because the operator must handle the priorization by his or herself. That is, the operator is compelled to distinguish important information from less important information, which requires time and effort. In addition, it is difficult to orient one's self to a display structured in this manner since the screen structure constantly changes.

Document EP 1 650 715 discloses a display procedure in which new information that is added and is needed for the particular process is visualized in an edge region of a display, while general machine-related information that was previously the only information visualized on the monitor is zoomed such that it is still readable. The new information is positioned in an outer region of the display that is easily accessed and, therefore, easier to edit. Although a visualization device structured in such a way ensures better orientation on the screen, the deice or system is disadvantageous in that the large amount of visualized information may not be required for the process currently underway resulting in unnecessary overstimulation of the driver operating the particular agricultural working machine when confronted with the visualized information.

### SUMMARY OF THE INVENTION

The present invention overcomes the shortcomings of known arts, such as those mentioned above.

To that end, the present invention provides a visualization device that only visualizes or presents context-relevant parameters and, that permits vehicle parameters to be easily changed.

In an embodiment, the electronic control and display unit is equipped with at least one display and at least one control unit. Icons representing parameter settings are assigned to the display in one or more visualization regions. Activating the icons causes at least one virtual adjusting element to be shown on the display that can be edited in order to change the parameter of the working machine. The electronic control and display unit so designed ensures that the vehicle parameters can be easily changed.

The virtual adjusting elements are user-friendly because they are designed as a virtual rotary switch and/or a virtual sliding switch. Preferably, the virtual rotary switch is made editable by dragging a marker in a circular motion. The virtual sliding switch is made editable by dragging a marker in a linear motion. The particular mark is activated via the touchscreen function of a display, which is designed as a touchscreen marker, or via control elements assigned to the display, preferably rotate-and-press switches. Flexible handling of the parameter adjustment is thereby achieved since the touchscreen function of a monitor and available control switches are used to change the particular parameter. While the use of switches has the advantage that shaking-induced disruptions of the fine-motor skills have little effect on operation, the use of a touchscreen function has the advantage that a parameter can be changed more quickly.

The activation of the virtual adjusting elements is simplified in the invention when editing buttons in the display for editing the particular parameter are assigned to the virtual sliding switch or the virtual rotary switch. Editing is carried out by touching the editing button on a display (designed as a touchscreen monitor), or via control elements assigned to the display, preferably rotate-and-press switches.

Operation of the control and display unit according to the invention that is very easily adaptable to the particular conditions results when a virtual sliding switch, a virtual rotary switch, and editing buttons, which all visualize the same parameter, are assigned to one or more of the visualization regions of the display. The parameter are changed by activating one of these virtual adjusting elements, wherein changing one of these adjusting elements causes at least one further adjusting element to change as well.

The control and display unit can be used in a highly flexible and efficient manner to optimize application conditions of an agricultural working machine when the parameters that can be edited using the control and display unit are any of machine parameters, quality parameters of the agricultural working machine, quality parameters of the crop and crop parameters.

In an embodiment, the virtual rotary switch provides a large amount of information and is highly transparent to the operator when the available value range of the parameter is visualized in an annular region in the virtual rotary switch, and the marker is moved in this annular region. In this context, the operator also is informed as to whether the parameter is in a permissible range or not when, in an advantageous development, the annular region has sections in different colors and the color of the particular section is a measure of the quality of the visualized parameter.

Pop-up windows are assigned to one or more of the visualization regions of the display. Each pop-up window comprises one or more icons, each of which represents a parameter. One or more of the icons can be changed using the editing elements. Such configuration and function ensure that parameters can be set in highly diverse working phases of the agricultural working machine.

Depending on the complexity of a selected tool, it may be necessary to edit parameters in several levels, wherein general settings as well as highly specific parameter settings can play a role. Taking this into consideration, the invention provides that a plurality of further pop-up windows can be activated, wherein each of the subsequently activated pop-up windows is positioned over the previously activated pop up window by being dragged horizontally into the visualization region of the display.

In an embodiment, the electronic control and display unit comprises at least one display having a plurality of visualization regions and can be operated in navigation levels, wherein the display is subdivided into visualization regions within a navigation level and at least a portion of the visualization regions can be moved relative to one another. Such configuration ensures that only context-relevant parameters are ever visualized and the visualization according to a repeating pattern results in the rapid orientation of the operator in the navigation levels. Given that the movability of the visualization regions relative to one another includes horizontal and/or vertical scrolling of the particular visualization region, the operator also is confronted with an efficient, widespread navigation structure that is easy to learn and quickly leads to the parameter to be selected on the display.

### BRIEF DESCRIPTION OF THE DRAWINGS

Further features and advantages of the invention will become apparent from the description of embodiments that follows, with reference to the attached figures, wherein:

FIG. 1 depicts an agricultural working machine, embodying a combine harvester, with a control and display unit of the invention;

FIG. 2A depicts the inventive control and display unit in a first navigation level;

FIG. 2B depicts the control and display unit in a second navigation level;

FIG. 3 depicts navigation using the inventive control and display unit in a first navigation level;

FIGS. 4A-D together depict how the display structure is changed in one navigation level according to the inventive control and display unit; and

FIGS. 5A-E together depict a sequence highlighting how parameters are changed in one navigation level, according to the invention.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

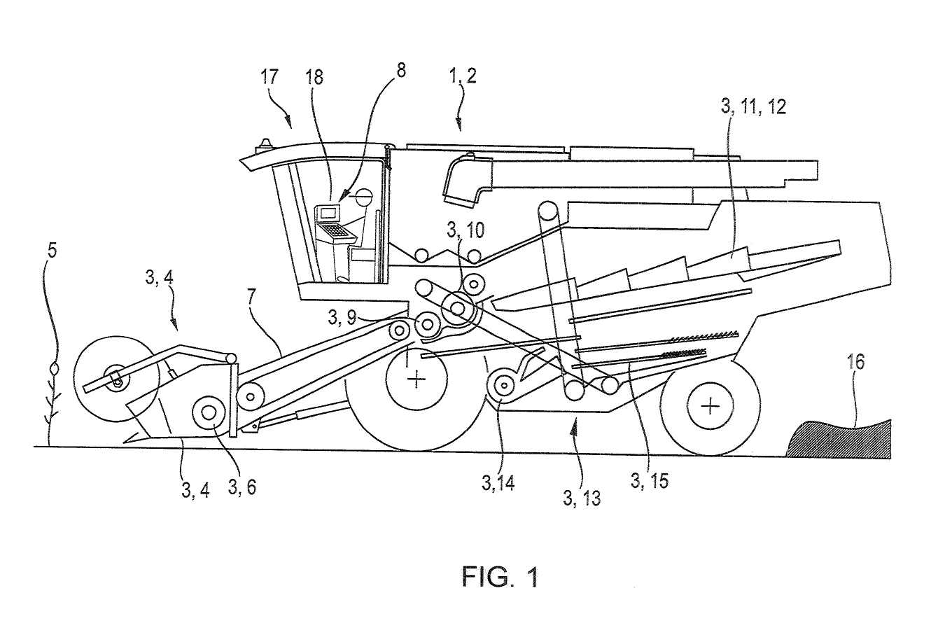

FIG. 1 depicts an agricultural working machine 1 configured as a combine harvester 2 and the working units 3 thereof. The combine harvester 2 accommodates a header 4 in the front region thereof. The header 4 picks up crop 5, cuts the crop and transfers the crop via a feed device 6 to the downstream feed rake 7. Via the feed rake 7, the crop 5 is transferred in a manner known per se to the threshing devices. In this case, the threshing devices comprise a first cylinder 9 and, downstream thereof, a second cylinder 10. To further separate the grain, the crop stream is conveyed to a separating device 11, such as a tray-type shaker 12, and to a cleaning device 13. The cleaning device comprises a fan 14 and cleaning sieves 15. The straw is ejected from the rear region of the combine harvester 2 and is deposited in a swath 16 on the ground or is widely distributed on the ground.

An electronic control and display unit 8 according to the invention is disposed in the cab 17 and allows the driver of the combine harvester 2 to enter the settings for the various working units 3 and thereby adapt the harvesting operation to the specific crop conditions. In addition, the driver of the combine harvester 2 always has an overview of the machine and/or crop data visualized in the display 18 of the control and display unit 8 disposed in the cab 17. While the agricultural working machine 1 depicted in FIG. 1 is a combine harvester 2, the invention is not limited to use therein but also may be incorporated in a forage harvester, a tractor of like agricultural working machine.

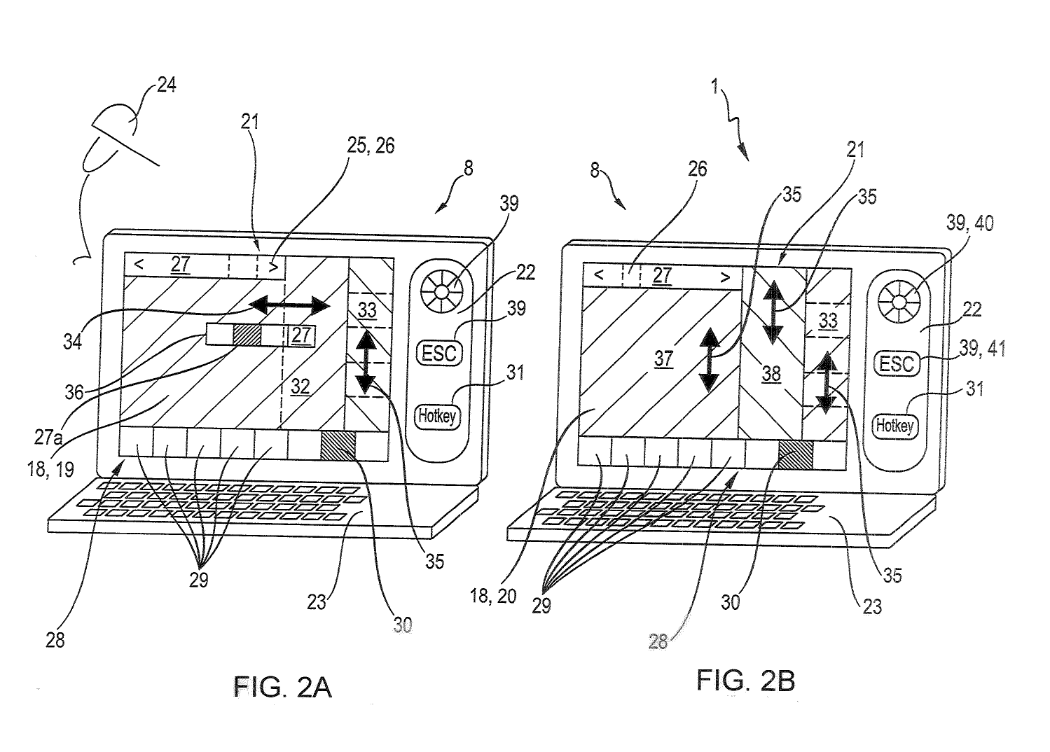

FIGS. 2A and 2B depict the inventive control and display unit 8. FIG. 2A depicts a first navigation level 19 and FIG. 2B depicts a second navigation level 20 of the display 18 associated with the control and display unit 8. In addition to the display 18, which is a touchscreen monitor 21, the control and display unit 8 comprises a first control unit 22. The first control unit 22 permits navigation within one navigation level 19, 20. At least one further control unit 23 enables an operator 24 to provide input. The first and second control units 22, 23 may be combined to form a single control unit in a non-illustrated manner, without deviating from the scope and spirit of the invention.

The display 18 is a touchscreen monitor 21 that includes a display region 26 at the top thereof. Display region 26 is designed as a header menu bar 25 and is displayed permanently at least in the first navigation level 19. The header menu bar 25 comprises the working phases 27 of the agricultural working machine 1. Each of the working phases 27 can be selected in that the operator 24 of the agricultural working machine 1 horizontally scrolls the header menu bar 25 via touchscreen functionality.

A further display region 28, which is visible at all navigation levels 19, 20, is associated with the display 18 at the lower edge thereof. Display region 28 comprises a “favorites” 29 display region and a “hotkey” 30 display region. System-relevant information is permanently visualized in the “favorites” 29 display region and navigation level-relevant information is visualized in the “hotkey” 30 display region by activating the particular display region 29. The navigation level-relevant information stored in the “hotkey” button 30 is activated either by touching this button on the display 18 (which is designed as a touchscreen monitor 21), or by pressing the “hotkey” button 31 disposed in the first control unit 22.

In an embodiment, the display 18 comprises, in a first navigation level 19, at least one “working phase” visualization region 32 and a “tool menu” visualization region 33. The operator 24 of the agricultural working machine 1 can navigate in the particular visualization region 32, 33 by horizontally scrolling 34 in the “working phase” navigation region 32 and vertically scrolling 35 in the “tool menu” visualization region 33. Since the display 18 is designed as a touchscreen monitor 21, the horizontal and vertical scrolling 34, 35 is accomplished by touching the display 18 and dragging the particular visualization region 32, 33 in the desired direction. To ensure that the operator 24 is informed about which working phase 32 is currently activated while scrolling in the “working phase” visualization region 32, a further display field 36 appears in the display 18. The further display field shows all the selectable working phases 27. The currently activated working phase 27a is visualized in an emphasized manner.

In the further navigation level 20, the display 18 comprises at least one “tool content” visualization region 37, a “tool menu” visualization region 33 and a “tool submenu” visualization region 38. Each of the visualization regions 33, 37, 38 is navigated by vertical scrolling 35. In a manner analogous to the first navigation level 19, the vertical scrolling 35 is carried out by touching the display 18 and dragging the particular visualization region 33, 37, 38 in the desired direction.

Moreover, in the second navigation level 20, navigation between the visualization regions 33, 37, 38 and within each visualization region 33, 37, 38 is carried out by control elements 39 assigned to the first control unit 22. In the depicted embodiment, the first control unit 22 comprises a control element 39. The control element 39 is designed as a rotate-and-press switch 40 and is rotated in order to switch back and forth between the visualization regions 33, 37, 38 and to navigate within a visualization region 33, 37, 38. The rotate-and-press switch 40 is pressed in order to confirm or select a selected function. The further control element 39 is designed as an escape button 41 and is used to reset an edit implemented using the rotate-and-press switch 40.

The display 18 is subdivided in the above-described first and second navigation levels 19, 20 into visualization regions 32, 33, 37, 38. At least one portion of the visualization regions 32, 33, 37, 38 can be moved relative to one another. Accordingly, a navigation style is created that enables the operator 24 of the agricultural working machine 1 to change machine parameters quickly and transparently. The orientation within the available navigation levels 19, 20 also is increased in that only horizontal scrolling 34 is implemented in a first navigation level 19, while only vertical scrolling 35 is implemented in the at least one further navigation level 90. The main effect thereof is that the operator 24 of the agricultural working machine recognizes which navigation level 19, 20 is currently being navigated on the basis of the movement of the visualization regions 32, 33, 37, 38.

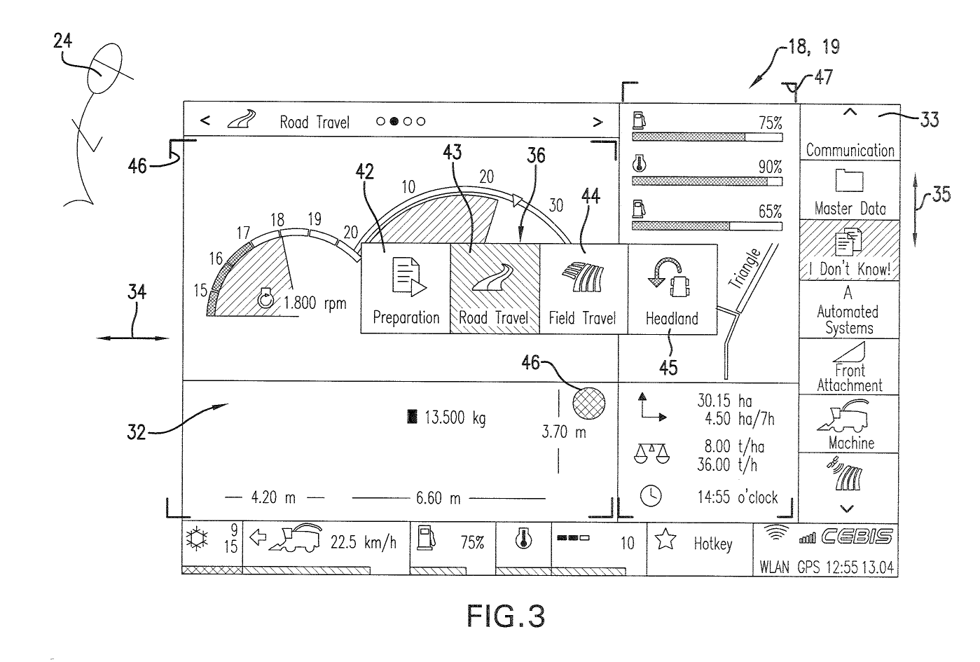

FIG. 3 shows a detailed view of the display 18 at the first navigation level 19. The display field 36, which visualizes the available working phases, comprises the working phases “preparation” 42, “road travel” 43, “field travel” 44, and “headland” 45. The visualization region of each working phase 42-45 is structured such that the visualization region comprises a “working phase content” visualization region 46 and at least one “tool view” visualization region 47. In the first navigation level 19, the operator 24 can select the desired working phase 42-45 by touching 48 the display 18 with a finger or a suitable object. That is, the operator either scrolls the “working phase” visualization region 32 in the horizontal direction 34 or taps the desired working phases 42-45 directly in the additional display field 36. Independently thereof, the operator 24 can navigate in the first navigation level 19 by vertical scrolling 35 in the “tool menu” visualization region 33.

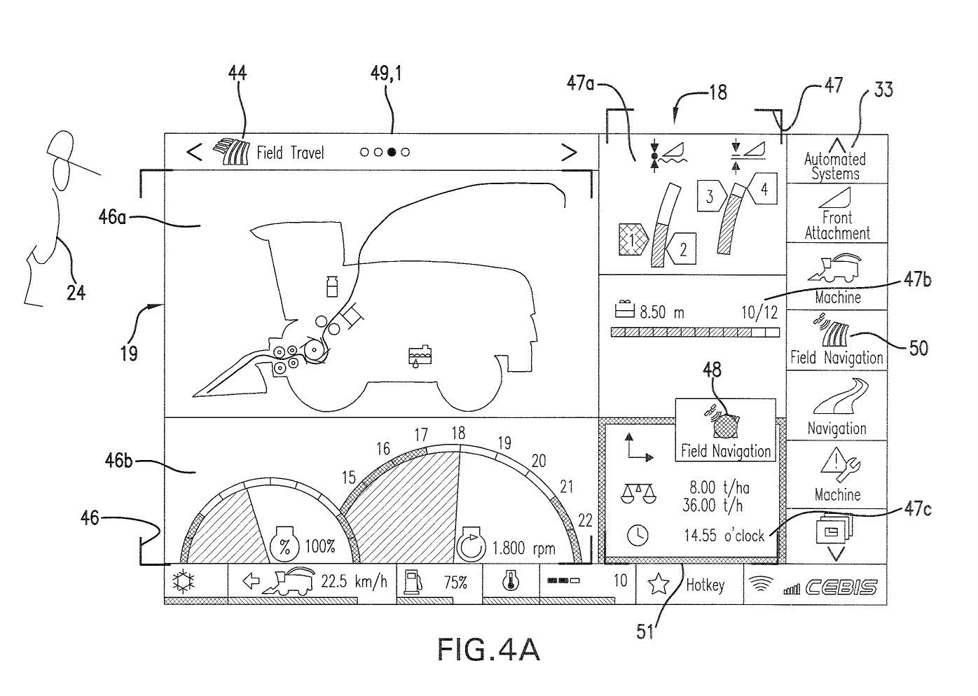

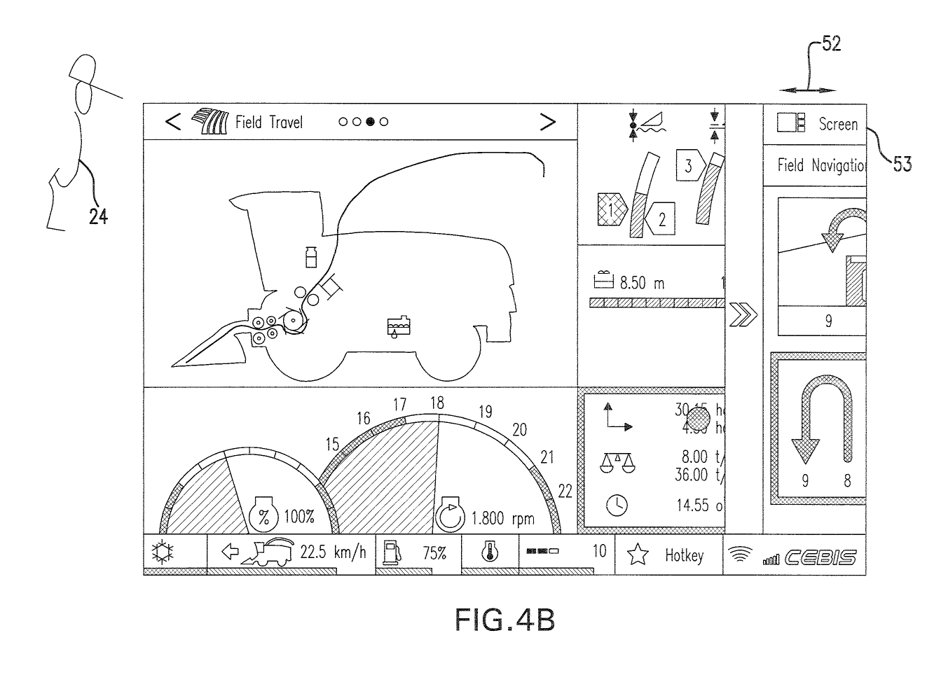

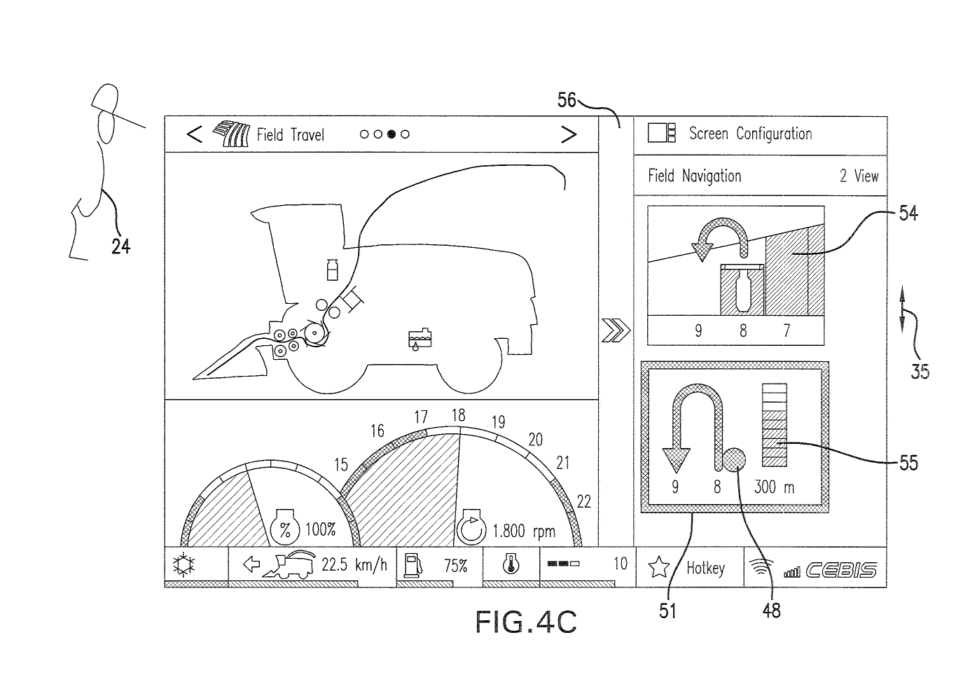

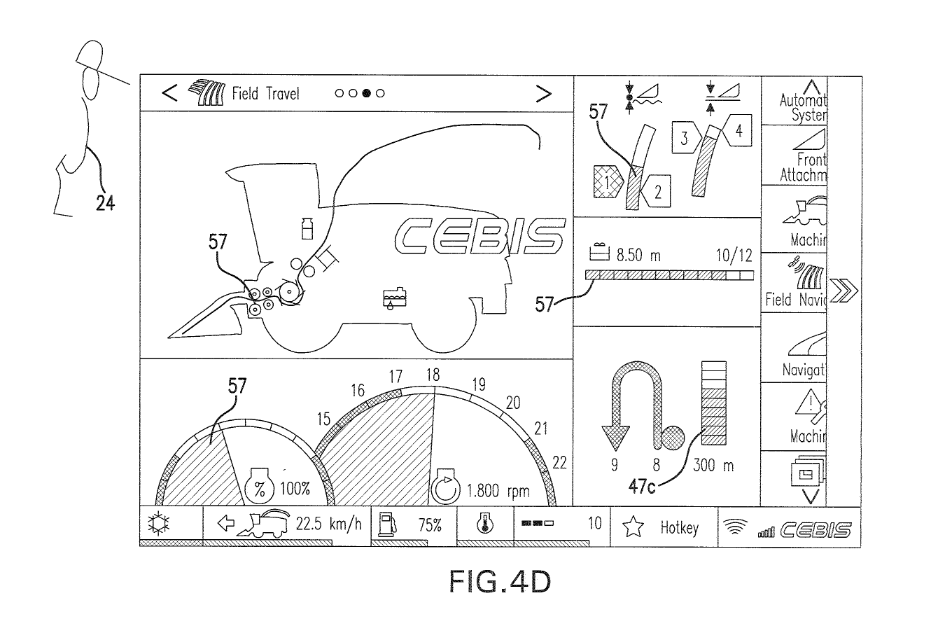

FIGS. 4A, 4B, $C and 4D together depict how the structure of the display 18 (in the self-propelled forage harvester 49, as an example) is changed in the first navigation level 19. Although the change in the display structure is described in the following by reference to the first navigation level 19, it lies within the scope of the invention for the procedure to be described to also be applied to change the display structure in the second navigation level 20. Hence, a description of the procedure for changing the display structure in the second navigation level 20 is omitted for simplicity.

In the exemplary embodiment shown, the operator 24 of the forage harvester 49 has selected the “field travel” working phase 44. Each of the “working phase content” 46 and “tool view” 47 visualization regions are subdivided into subregions 46a-b, 47a-c, wherein the bits of information visualized in the subregions 46a-b, 47a-c can be replaced within subregions. To perform editing, the operator 24 first selects a tool 50, the “field navigation” tool in this case, via touch 48 in the “tool menu” visualization region 33 and drags it to one of the subregions 46a-b, 47a-c of the “working phase content” 46 or “tool view” 47 visualization regions.

In the embodiment shown, the “field navigation” tool 50 is dragged to the lowermost subregion 47c of the “tool view” visualization region 47. The activation of the subregion 47c is indicated by a border 51, which is emphasized using color. If the operator 24 interrupts the contact in this subregion 47c, a pop-up window 53, which moved into the display from right to left in the horizontal direction 52, opens. The pop-up window comprises two alternative editing options 54, 55 for the “field navigation” tool 50 in this case. Given that the operator 24 selects, via touch 48, one of the alternative editing options 54, 55 from the pop-up window 53 (the pop-up window 53 completely covers the “tool view” visualization region 47), this editing option 55 is initially visually emphasized to indicate the selection thereof. In the simplest case, the edge 51 is emphasized using color. If the operator 24 then activates a close bar 56 positioned in the pop-up window 53, the pop-up window 53 is closed by moving it horizontally 52 out of the display 18 and, simultaneously, the selected editing option 55 has filled the previously selected, lowermost subregion 47c of the “tool view” visualization region 47.

It lies within the scope of the invention for the selectable editing options 54, 55 to not be limited to visual aspects, but rather to also have various functions. It also is possible for more than the two described editing options 54, 55 to be available, in which case navigation between the selectable editing options 54, 55 can be carried out by vertical scrolling 35 in the open pop-up window 53.

To switch from the first navigation level 19 to the next navigation level 20 after a desired working phase has been selected, the operator 24 touches one of the “working phase content” 46 or “tool view” 38 visualization regions. If the touch 48 takes place in the region of one of the icons 57 visualized on the display 18, the function or application associated with the icon 57 that is touched opens immediately. If a region between the icons 57 is touched, the only result is the switch between the navigation levels 19, 20, without this directly changing the display structure.

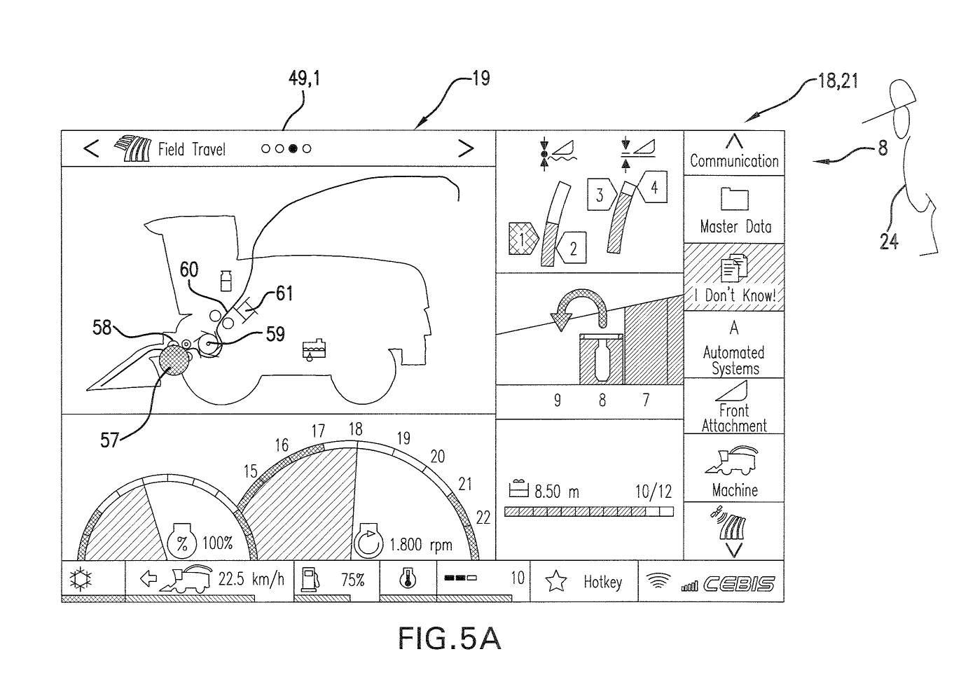

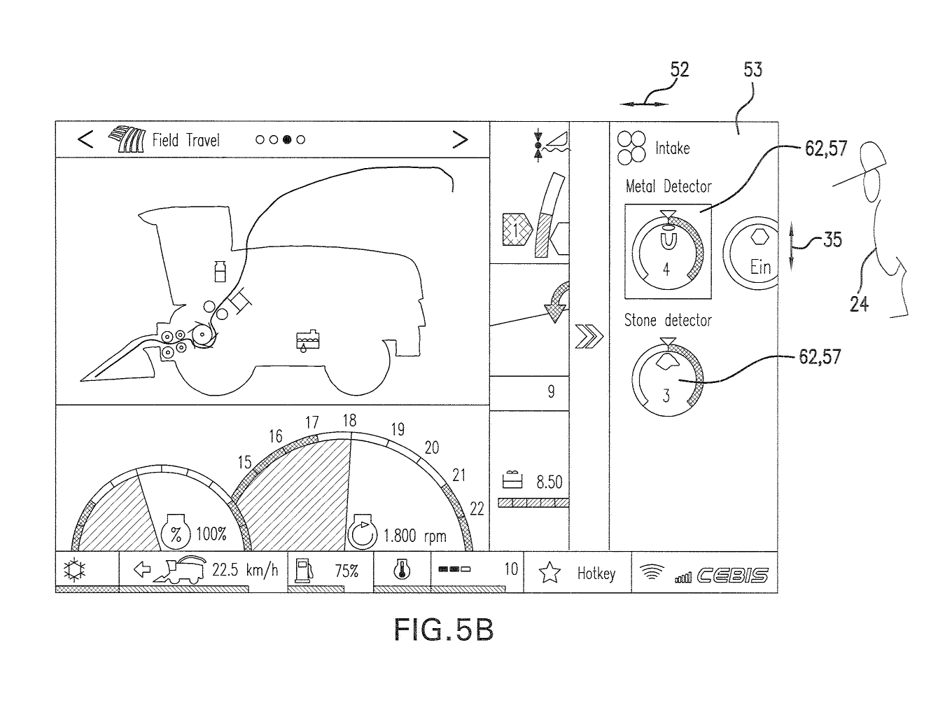

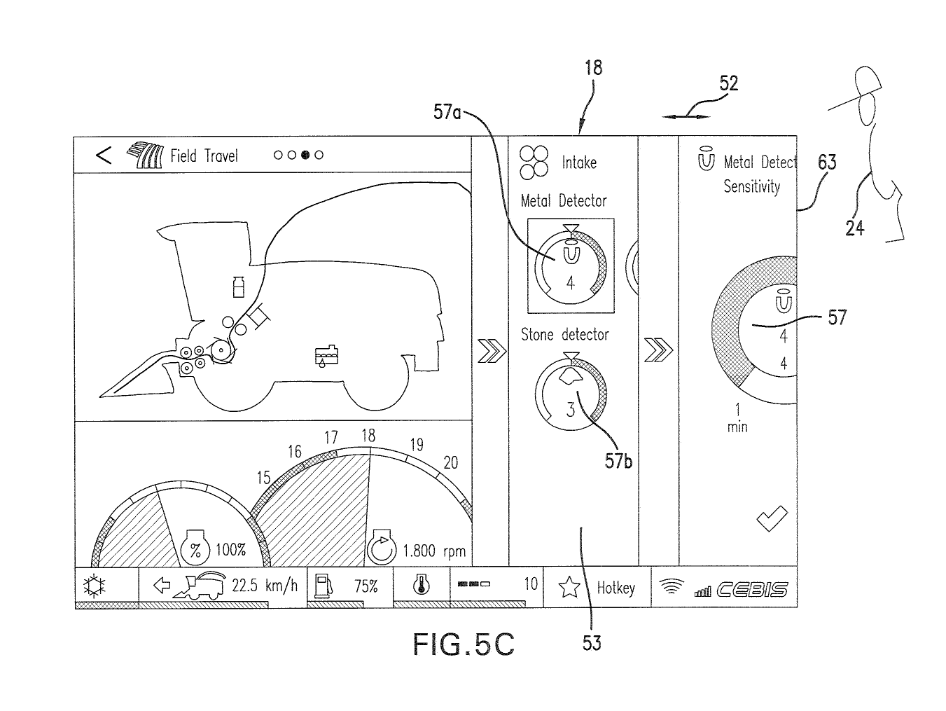

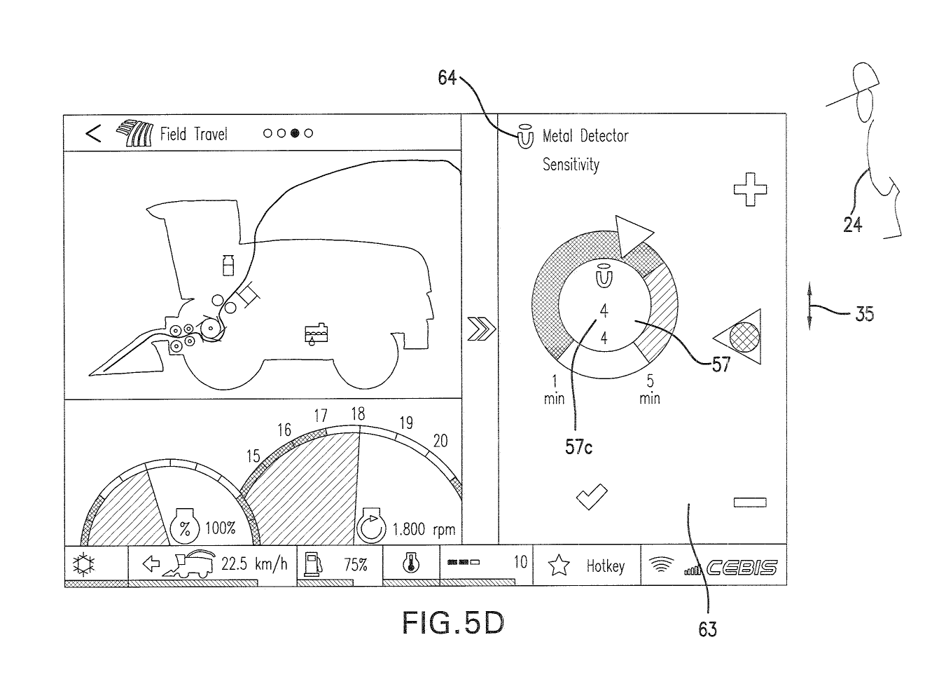

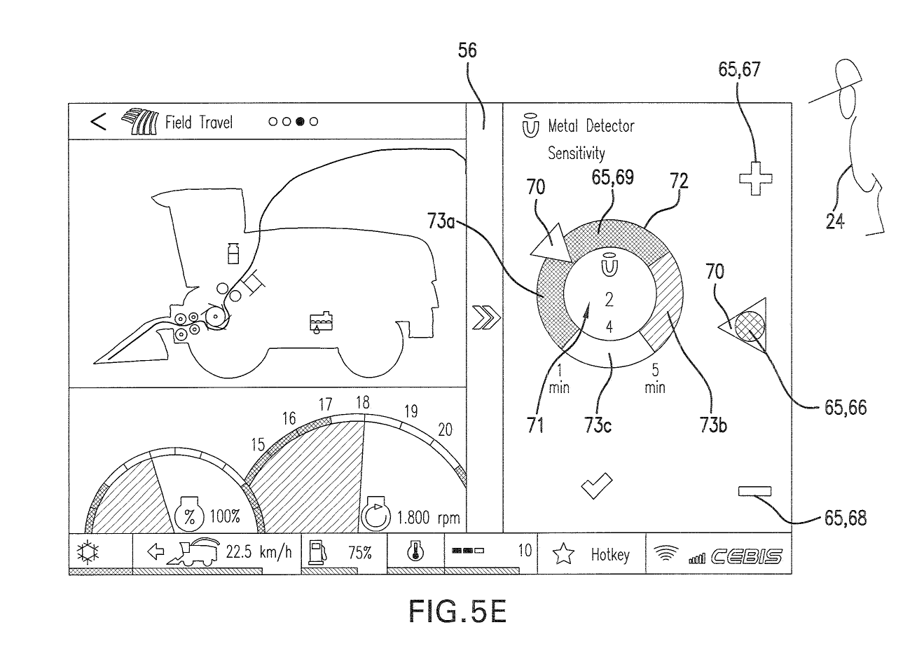

FIGS. 5A, 5B, 5C, 5D and 5E together provide a sequence that together describe a further variant of navigation in the first menu level 19, wherein the agricultural working machine 1 is a forage harvester 49. The forage harvester 49 comprises intake conveyor mechanisms 58, a chopping assembly 59, a post-fragmentation device 60 disposed downstream thereof and a post-accelerator 61 for conveying the chopped crop out of the forage harvester 49. In order to describe the parameter change according to the invention, reference will be made to the sensitivity setting of a metal detector in the region of the intake conveyor mechanisms 58 of the forage harvester 49.

First, the operator 24 touches the display 18 (which is a touchscreen monitor 21), in the region of the icon 57 that represents the intake conveyor mechanisms 58. The touch activates another pop-up window 53, which contains different content. The pop-up window 53 then moves into the display 18 once more in the horizontal direction 52, wherein the pop-up window 53 at least partially overlaps the available display surface of the display 18. In analogy to the previously described changing of the display structure, a plurality of editing options 62, such as the editing of a metal detector and the editing of a stone detector in this case, are available in the pop-up window 53.

The operator 24 then selects the desired editing option 62, namely changing parameters of the metal detector in this case, by touching the icon 57 representing the editing option 62. The selected icon 57 changes color to indicate selection thereof. Another pop-up window 63 then opens automatically in such a way that it is moved into the display 18 in the horizontal direction 52 and, in the editable position thereof, completely covers the previously opened pop-up window 53. As shown, the pop-up window 63 (which is now open), comprises a plurality of icons 57 used for editing parameters 64 of the agricultural working machine 1 (designed as a forage harvester 49), namely, the sensitivity of the metal detector in this case.

In addition to the two above-described pop-up windows 53, 63, a plurality of pop-up windows can be positioned over one another. The number of pop-up windows depends on the editing function to be depicted and, which, in a preferred embodiment, should not exceed two. The particular pop-up window 53, 63 is closed by activating a closing bar 56 associated with the particular pop-up window 53, 63 or, by activating the previously described escape button 41. In addition, each of the pop-up windows 53, 63 can be designed such that the available editing options 62 and parameters 64 can be navigated by vertical scrolling 35 within the particular pop-up window 53, 63 in a case where it is not possible to display all available editing options 62 and parameters 64 in a single display region in a meaningful manner.

Also, the editable parameter 64 is represented by a corresponding icon 57a-c in the particular open pop-up window 53, 63. This enables that a plurality of icons 57 representing parameters 64 can be assigned to a working mechanism of the agricultural working machine 1, namely, the intake conveyor mechanisms 58 of a forage harvester 49 in this case. In order to change the particular visualized parameter 64, the particular icon 57 is designed as a virtual adjusting element 65. The virtual adjusting element enables the particular parameter 64 to be changed. As shown, the virtual adjusting element 65 has a virtual rotary switch 69, a virtual sliding switch 66, and editing buttons, which are designed as plus and minus buttons 67, 68. A marker 70 is assigned to the virtual sliding switch 66 and to the virtual rotary button 69 for identification of the specific value of the visualized parameter 64.

The particular parameter 64 is changed by touching the marker 70 directly on the display 18 (which is a touchscreen monitor 21). A first change mode is that of making a change using the virtual sliding switch 66, in which the marker 70 is moved linearly in the vertical direction. The position of the marker 70 also can be changed by touching the plus and minus buttons 67, 68 directly on the touchscreen monitor 21. It also is possible to change the parameter 64 using a virtual rotary switch 69 in such a way that the position of the marker 70 is changed by touching the touchscreen monitors 21 with a circular motion. Preferably, all the change modes are integrated in the display 18, thereby permitting the parameter 64 to be changed by the linearly displaceable marker 70 of the virtual sliding switch 66, while the marker 70 of the virtual rotary switch 69 directly displays the actual value of the changed parameter 64.

The invention also allows for only one change mode to be available on the display 18, wherein the virtual sliding switch 66 must indicate the change not only in a qualitative manner, e.g. + means higher and − means lower, but also in a quantitative manner. The virtual adjusting elements 65 assigned to the display 18 also can be activated by actuating the control elements 39 (see description of FIG. 2), preferably by actuating the rotate-and-press switch 40.

The information content of the virtual rotary switch 69 is quickly grasped when the available value range 71 of the parameter 64 is visualized in an annular region 72 in the virtual rotary switch 69 and the marker 70 is moved in this annular region 72. The annular region 72 has sections 73a-c of different colors. The color of the particular section 73a-c is a measure of the quality of the visualized parameter 64. For example, red can be selected for critical values and green can be selected for optimal values.

It lies within the scope of the invention that the agricultural working machine 1, which may be controlled using the inventive control and display unit 8, is not limited to a combine harvester 2 or a forage harvester 49, but rather to have any possible agricultural working machine design known to those with skill in the art, e.g., a tractor-mounted implement combination. In addition, the parameters 64 that are set using the control and display unit 8 can be of any type, such as machine parameters, quality parameters of the agricultural working machine, quality parameters of the crop, and crop parameters.

### LIST OF REFERENCE CHARACTERS

1 agricultural working machine

2 combine harvester

3 working unit

4 header

5 crop

6 feed device

7 feed rake

8 control and display unit

9 first cylinder

10 second cylinder

11 separating device

12 tray-type shaker

13 cleaning unit

14 fan

15 cleaning sieve

16 swath

17 cab

18 display

19 first navigation level

20 second navigation level

21 touchscreen monitor

22 first control unit

23 second control unit

24 operator

25 header menu bar

26 display region

27 working phases

28 display region

29 “favorites” display region

30 “hotkey” display region

31 “hotkey” button

32 “working phases” visualization region

33 “tool menu” visualization region

34 horizontal scrolling

35 vertical scrolling

36 display field

37 “tool content” visualization region

38 “tool submenu” visualization region

39 control element

40 rotate-and-press switch

41 escape button

42 preparation

43 road travel

44 field travel

45 headland

46 “working phase content” visualization region

46a, b subregion

47 “tool view” visualization region

48 touch

49 forage harvester

50 tool

51 border

52 horizontal direction

53 pop-up window

54, 55 editing option

56 closing bar

57 icon

57a-c icon

58 intake conveyor mechanisms

59 chopping assembly

60 post-fragmentation device

61 post-accelerator

62 editing option

63 pop-up window

64 parameter

65 virtual adjusting element

66 virtual sliding switch

67 “plus” editing button

68 “minus” editing button

69 virtual rotary switch

70 marker

71 available value range

72 annular region

73a-c sections

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An electronic control and display unit, comprising
at least one display; and
at least one control unit;
wherein the display has a plurality of visualization regions and icons representing parameter settings are assigned to one or more of the visualization regions,
wherein a particular icon (57) represents a parameter (64) of a working machine (1) and activating the icon (57) results in at least one virtual adjusting element (65) being shown on the display (18); and
wherein a virtual adjusting element (69) is editable to change the parameter (64) of the working machine (1).

2. The electronic control and display unit according to claim 1, wherein the at least one virtual adjusting element (65) is a virtual rotary switch (69) or a virtual sliding switch (66) or both.

3. The electronic control and display unit according to claim 2, wherein the virtual rotary switch (69) is made editable by dragging a marker (70) in a circular motion, wherein the virtual sliding switch (66) is made editable by dragging a marker (70) in a linear motion, and wherein the marker (70) is activated via the touchscreen function of a display (18) or via control elements (39) configured as rotate-and-press switches (40)

4. The electronic control and display unit according to claim 3, wherein editing buttons (67, 68) in the display (18) for editing the particular parameter are assigned to the virtual sliding switch (66) or the virtual rotary switch (69), wherein editing is carried out by touching the editing button (67, 68) on a display (18) or via control elements (39) configured as rotate-and-press switches (40).

5. The electronic control and display unit according to claim 2, wherein a virtual sliding switch (65, 66), a virtual rotary switch (65, 69) and editing buttons (65, 67, 68), which all visualize the same parameter (65), are assigned to one or more of the visualization regions (32, 33, 37, 38, 46, 47) of the display (18), wherein the parameter (64) is changed by activating one of these virtual adjusting elements (65) and wherein changing at least one of these adjusting elements (65) causes the further adjusting elements (65) to change as well.

6. The electronic control and display unit according to claim 1, wherein the working machine is designed as an agricultural working machine (1) and the editable parameters (64) include any of machine parameters, quality parameters of the agricultural working machine (1), quality parameters of the crop and crop parameters.

7. The electronic control and display unit according to claim 1, wherein an available value range (71) of the parameter (64) is visualized in an annular region (72) in the virtual rotary switch (69) and wherein the marker (70) is moved in this annular region (72).

8. The electronic control and display unit according to claim 7, wherein the annular region (72) has sections (73a-c) of different colors and the color of the particular section (73a-c) is a measure of the quality of the visualized parameter (64).

9. The electronic control and display unit according to claim 1, wherein pop-up windows (53) are assigned to one or more of the visualization regions (32, 33, 37, 38, 46, 47) of the display, wherein each pop-up window (53) has one or more icons (57) that represent a parameter (64) and wherein one or more of the icons (57) is changed using the editing elements (65).

10. The electronic control and display unit according to claim 9, wherein a plurality of further pop-up windows (63) can be activated, wherein each of the further activated pop-up windows (63) is positioned over the previously activated pop-up window (63) by being dragged horizontally (52) into the visualization region of the display (18).

11. The electronic control and display unit according to claim 1, wherein the display (18) is operated in navigation levels (19, 20), wherein the display (18) is subdivided into visualization regions (32, 33, 37, 38, 46, 47) within a navigation level (19, 20), and wherein at least a portion of the visualization regions is movable relative to one another and wherein movability of the visualization regions relative to one another includes horizontal or vertical scrolling (34, 35) of the particular visualization region or both.
